(19) United States
(12) Patent Application Publication
(10) Pub. No.: US 2009/0235488 A1
(43) Pub. Date: Sep. 24, 2009

(54) Position-fixing hinge

(75) Inventor: Hsiang-Chi Chien, Taipei Hsien (TW)

Correspondence Address: POSZ LAW GROUP, PLC, 12040 SOUTH LAKES DRIVE, SUITE 101, RESTON, VA, 20191, US

(73) Assignee: SHIN ZU SHING CO., LTD, Taipei Hsien (TW)

(21) Appl. No.: 12/076,670

(22) Filed: Mar. 21, 2008

(51) Int. Cl. E05D 11/10

(52) U.S. Cl. 16/327

(57) ABSTRACT

A position-fixing hinge has a housing, a pintle and a fixing member. The housing defines an inner space and is mounted in a base of a portable electronic device. The pintle is mounted longitudinally in the housing, is rotatably relative to the housing and has an outer end and an inner end. The outer end connects with a connector to mount a cover of the portable electronic device. The inner end defines a tongue. The fixing member is movably mounted in the housing, has an engaging portion corresponds to and selectively engages the tongue of the pintle by a faces inter-pressing manner. Such that the cover connected with the pintle is securely held at any determined position. Furthermore, abrasion and deformation are effectively prevented, such that the position-fixing hinge is available for a long term of use.

### BACKGROUND OF THE INVENTION

1. Field of the Invention

The present invention relates to a hinge, and more particularly to a position-fixing hinge that is compact, able to hold a cover securely at an optimum position and available for a long term of use.

2. Description of Related Art

Portable electronic devices such as notebook computers, cellular phones and the like are commonly used in daily life. Generally, a portable electronic device comprises a base, a cover and a hinge. The cover usually has a display. The hinge pivotally connects the cover to the base, and allows the cover to pivot away from the base when the electronic device is in use.

For content people's demand, the conventional hinge is designed to have a cover-positioning function that holds the cover of the portable electronic device at an optimum position to facilitate users to watch. However, the conventional hinge having cover-positioning function is generally constructional complicated and bulky.

Otherwise, a vibration of the cover connected with the conventional hinge occurs when the portable electronic device is in unstable status, like in a jolting car.

Moreover, since abrasion and deformation may occur in the components of the hinge during a long term of use, the ability of the hinge of securely holding the cover is inevitably lost.

To overcome the shortcomings, the present invention provides a position-fixing hinge to obviate or mitigate the aforementioned problems.

### SUMMARY OF THE INVENTION

The main objective of the present invention is to provide a position-fixing hinge that is compact, able to hold a cover securely at an optimum position and available for a long term of use.

To achieve the objective, the position-fixing hinge in accordance with present invention comprises a housing, a pintle and a fixing member.

The housing is able to be mounted securely in a base of a portable electronic device and has an inner space and a side aperture communicating with the inner space.

The pintle is mounted longitudinally through the inner space of the housing, is rotatable relative to the housing and has an outer end and an inner end. The outer end extends out from the housing and is connected with a connector that connects with a cover of the portable electronic device. The inner end defines a tongue with at least one transversal plane surface.

The fixing member is longitudinally mounted in the inner space of the housing in a controllable to move yet unrotatable manner, is pushed by a resilient element to abut the inner end of the pintle and has an engaging portion. The engaging portion corresponds to and selectively engages the tongue of the pintle and defines transversely at least one engaging surface selectively abutting the plane surface of the tongue to keep the pintle from rotating.

In such a manner, the cover connected with the pintle is securely held at any determined position.

Accordingly, the position-fixing hinge in accordance with present invention is compact and holds the cover stably when in use. Furthermore, since engagement generated by a faces inter-pressing manner, abrasion and deformation are effectively prevented, such that the position-fixing hinge is available for a long term of use.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a position-fixing hinge in accordance with the present invention;

FIG. 2 is a perspective view of the position-fixing hinge in FIG. 1;

FIG. 3 is a side view of the position-fixing hinge in FIG. 1;

FIG. 4 is a cross sectional side view of the position-fixing hinge in FIG. 1;

FIG. 5 is a partial perspective view of the position-fixing hinge in FIG. 1; and

FIG. 6 is an operational front view of the position-fixing hinge in FIG. 1 mounted in a portable electronic device.

### DETAILED DESCRIPTION OF THE PREFERRED EMBODIMENT

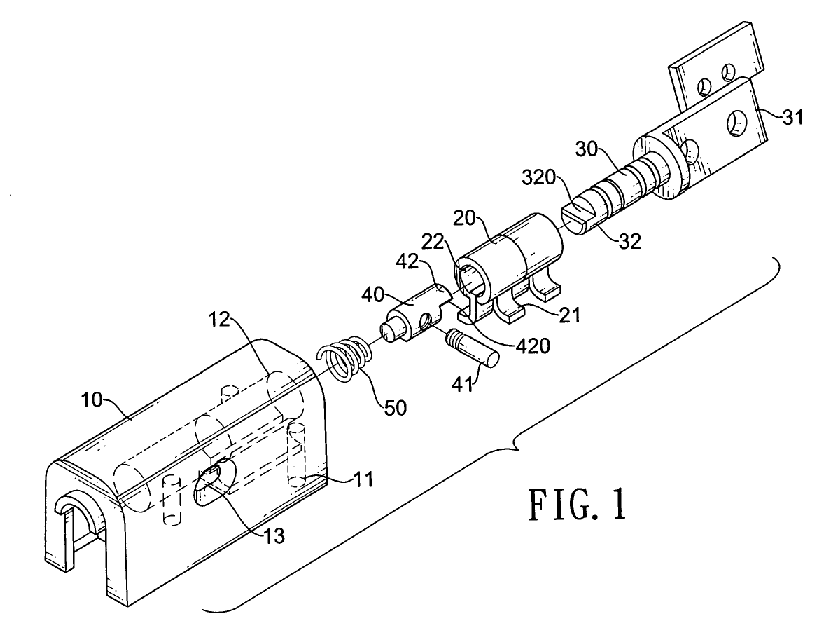

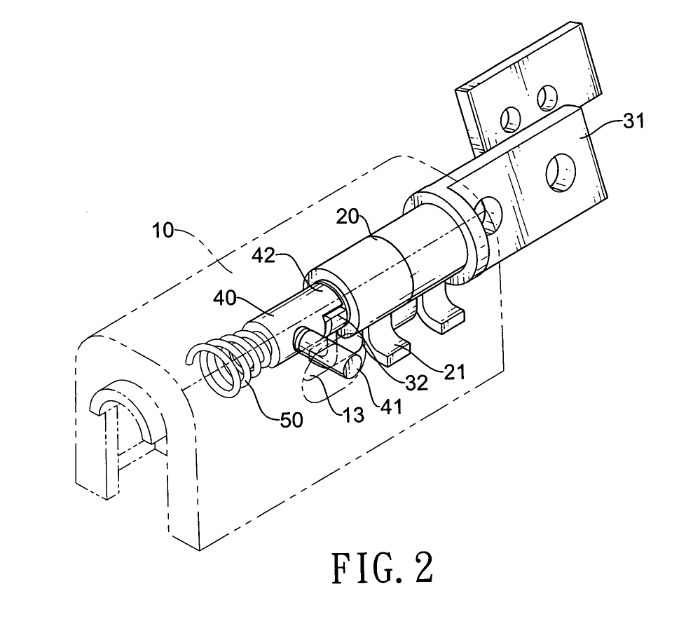

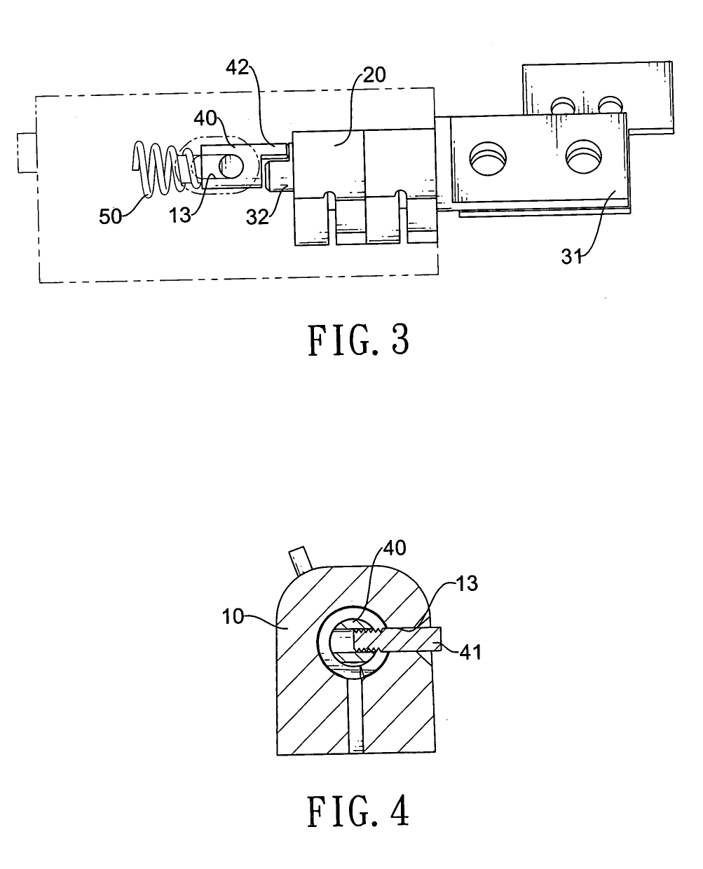

With reference to FIGS. 1, 2 and 3, the position-fixing hinge in accordance with present invention comprises a housing (10), a stage (20), a pintle (30), a fixing member (40) and a resilient element (50).

The housing (10) has an inner space (12), a side aperture (13) communicating with the inner space (12), a bottom and multiple mounting holes (11) formed in the bottom.

The stage (20) is mounted securely in the inner space (12) of the housing (10) and has an axial hole (22) and multiple legs (21). The axial hole (22) is longitudinally defined through the stage (20). The legs (21) are formed on a bottom of the stage (20) to be attached securely in the housing (10).

The pintle (30) is rotatably mounted longitudinally in the axial hole (22) of the stage (20), is rotatable relative to the housing (10) and has an outer end and an inner end. The outer end extends out from the housing (10) and is connected with a connector (31). The inner end defines a tongue (32) with a transversal plane surface (320).

With further reference to FIG. 4, the fixing member (40) is longitudinally mounted movably in the housing (10) adjacent to the inner end of the pintle (30) and has an engaging portion (42) and a side rod (41). The engaging portion (42) corresponds to and selectively engages the tongue (32) in the inner end of the pintle (30) and defines transversely an engaging surface (420) selectively abutting the plane surface (320) of the tongue (32). The side rod (41) protrudes transversely from a side of the fixing member (40) and extends through the side aperture (13) of the housing (10) for manual control and keeping the fixing member (40) from rotating relative to the housing (10).

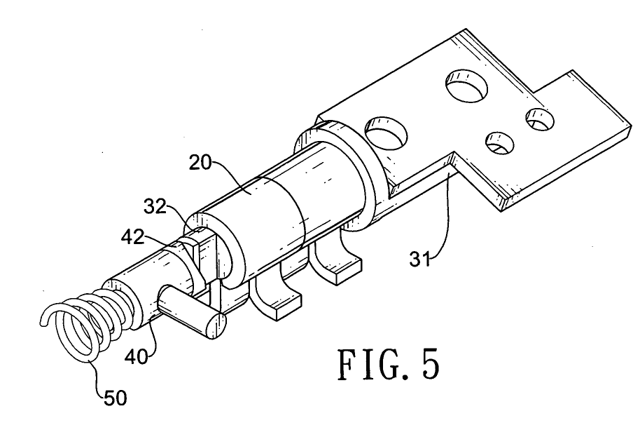

With further reference to FIG. 5, the resilient element (50) is mounted immovably in the inner space (12) of the housing (10) and has an end biases the fixing member (40) to make the engaging portion (42) of the fixing member (40) abut the tongue (32) of the pintle (30).

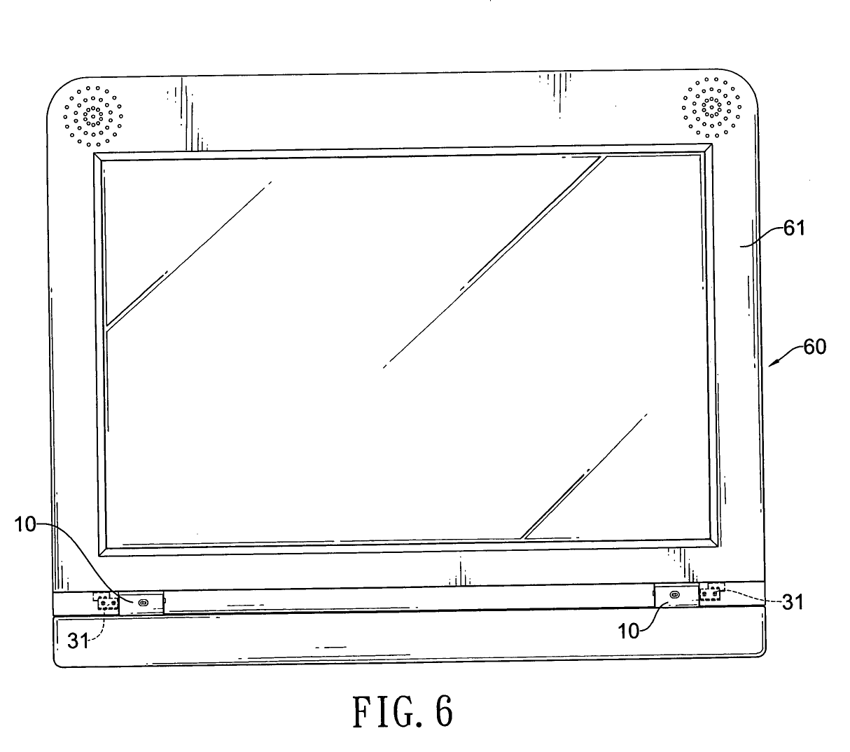

With further reference to FIG. 6, a portable electronic device (60) may be a laptop and has a cover (61) and a base (62). The position-fixing hinge in accordance with present invention is mounted between the cover (61) and the base (62). The housing (10) is mounted securely on the base (62) of the portable electronic device (60) via multiple fasteners mounted in the mounting holes (11), and the connector (31) on the pintle (30) connects securely with the cover (61).

When the cover (61) is pivoted relative to the base (62), the pintle (30) rotates with the cover (61). After the cover (61) being pivoted to a determined position where the engaging surface (420) and the plane surface (320) abut with each other, the engaging portion (42) of the fixing member (40) pushed by the resilient element (50) corresponds to and engages the tongue (32) of the pintle (30). Consequently, the engaging surface (420) of the engaging portion (42) presses against the plane surface (320) of the tongue (32) to keep the pintle (30) from further rotating. Such that the cover (61) connected with the pintle (30) is securely held in the determined position. Afterward, people can push the side rod (41) of the fixing member (40) to move backward the fixing member (40), so as to unlatch the engagement between the engaging portion (42) and the tongue (32) and allows the cover (61) to pivot freely.

Accordingly, the position-fixing hinge in accordance with present invention is compact and holds the cover (61) stably when the portable electronic device (60) is in use. Furthermore, since engagement generated by a faces inter-pressing manner, abrasion and deformation are effectively prevented, such that the position-fixing hinge is available for a long term of use.

Additionally, by changing of an inclined degree of the plane surface (320) or the engaging surface (420), the position of the cover (61) will be changed accordingly. In the present embodiment, the engagement between the tongue (32) and the engaging portion (42) occurs when the cover (61) is pivoted to an optimum position for watching. In another preferred embodiment, the engagement between the tongue (32) and the engaging portion (42) occurs when the cover (61) is covered relative to the base (62).

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A position-fixing hinge comprising
a housing having
an inner space; and
a side aperture communicating with the inner space;
a pintle being mounted in and rotatable relative to the housing and having
an outer end extending out from the housing and connected with a connector; and
an inner end defining a tongue with a transversal plane surface;
a fixing member being longitudinally mounted movably in the housing adjacent to the inner end of the pintle and having
an engaging portion corresponding to the tongue in the inner end of the pintle and defining transversely an engaging surface selectively abutting the plane surface of the tongue; and
a side rod protruding transversely from a side of the fixing member and extending through the side aperture of the housing for manual control and keeping the fixing member from rotating relative to the housing; and
a resilient element being mounted immovably in the inner space of the housing and having an end biasing the fixing member to make the engaging portion of the fixing member abut the tongue of the pintle.

2. The position-fixing hinge as claimed in claim 1 further comprising a stage being mounted securely in the inner space of the housing and having
an axial hole being longitudinally defined through the stage; and
multiple legs being formed on a bottom of the stage to be attached securely in the housing; and
the pintle is rotatably mounted longitudinally in the axial hole of the stage and the fixing member is longitudinally mounted movably in the housing.

3. The position-fixing hinge as claimed in claim 2, wherein the housing further has a bottom and multiple mounting holes formed in the bottom of the housing.
